(19) United States
(12) Patent Application Publication
(10) Pub. No.: US 2006/0247124 A1
(43) Pub. Date: Nov. 2, 2006

(54) Polymerisation reaction and catalyst therefor

(76) Inventors: Martin Graham Partridge, Cleveland (GB); Matthew Gwilym Davidson, Bath (GB); Gillian Frances Eade, Portmouth (GB)

Correspondence Address: RATNERPRESTIA, P O BOX 980, VALLEY FORGE, PA, 19482-0980, US

(21) Appl. No.: 10/538,341

(22) PCT Filed: Dec. 10, 2003
(86) PCT No.: PCT/GB03/05386

§ 371 Date: Apr. 21, 2006

(30) Foreign Application Priority Data
Dec. 11, 2002 (GB) 0228888.4

(51) Int. Cl. B01J 31/00

(52) U.S. Cl. 502/150; 502/152; 502/162; 502/167; 502/168; 502/155; 502/172

(57) ABSTRACT

The invention provides a compound suitable for use as a catalyst for ring opening polymerisation reactions for example for the polymerisation of lactones, lactides etc, the catalyst comprising the reaction product of (i) an alkoxide, halide, condensed alkoxide, amide, condensed amide, mixed halo-alkoxide or, mixed halo-amide, sulphonic acid derivative, sulphonamide, silanol or silylamide of titanium zirconium, hafnium or aluminium or a mixture thereof, and (ii) a complexing compound selected from the list comprising oximes, hydroxy-Schiff bases, 8-hydroxyquinoline derivatives, 10-hydroxybenzo-[h]-quinoline derivatives, hydrazones and substituted phenols.

This application concerns catalyst compositions, for use as catalysts for the ring-opening polymerisation of oxygen- and nitrogen-containing cyclic compounds, polymerisable mixtures containing these catalyst compositions, methods for their preparation and methods of carrying out ring-opening polymerisation reactions using the catalyst compositions of the invention.

Ring-opening polymerisations are an important route to polylactones and polylactides which are useful as biocompatible and biodegradable polymers. Conventional ring-opening polymerisations are carried out using a strong base and a catalyst such as dibutyltin dilaurate. However in these systems it has been difficult to obtain a polymer having a narrow molecular weight distribution (as indicated by a low polydispersity M_{w}/Mₙ).

Aida et al (Macromolecules 2000, 33, 725-729) have described the use of bulky titanium bis(phenolate) complexes as initiators for living anionic polymerisation of ε-caprolactone to produce polyesters with a narrow molecular weight distribution. The ligands used were methylene-bridged bisphenols containing bulky tert-butyl- or phenyl-substituents.

EP-A-0943641 describes a process for the preparation of monodisperse polymers from cyclic lactone and/or carbonate monomers by ring-opening polymerisation using a titanium- or aluminium-based Lewis acid catalyst which is a metal alkoxide of a substituted phenol, and an initiator.

Lin et al (Organometallics 2001, 20, 5076-5083) describe the ring-opening polymerisation of ε-caprolactone and δ-valerolactone using as initiator a dimeric compound of 2,2′-methylenebis(4-chloro-6-isopropyl-3-methylphenol) and isopropanol with aluminium. Chisholm et al (J. Am. Chem. Soc. 2000, 122, 11845-11854) have described the formation of polylactides by ring-opening polymerisation using magnesium and zinc alkoxides with trispyrazolyl and trisindazolylborate ligands. Kim and Verkade describe the formation of polylactides by ring-opening polymerisation using titanatranes (Organometallics, 2002, 21, 2395-2399).

EP-A-0710685 describes the preparation of biodegradable aliphatic polyesters prepared by polycondensing cyclic acid anhydrides with cyclic ethers in the presence of ring-opening polymerisation catalysts such as alkoxyzirconium compounds or oxyzirconium salts.

JP-04-257545 describes the preparation of co-polyesters of polycaprolactone and hydroxyalkyl (meth)acrylate by ring-opening polymerisation of ε-caprolactone in the presence of hydroxyalkyl (meth)acrylate and titanium tetra-butoxide.

DE-A-2947978 describes the use of Mo(OPr)₄, V(OBu)₃, VO(OBu)₃, Mo(VI) acetylacetonate, Mo or V naphthen ate, zinc bis(acetylacetonate), bis(acetylacetonato)titanium oxide, and similar compounds as catalysts for the ring-opening polymerisation of ε-caprolactone, δ-valerolactone, dodecanolactone, and similar lactones.

It is an object of the present invention to provide an alternative catalyst system for ring-opening polymerisation reactions.

According to the invention, we provide a compound suitable for use as a catalyst for the formation of polyoxyenates comprising the reaction product of

(i) an alkoxide, halide, condensed alkoxide, amide, condensed amide, mixed halo-alkoxide or, mixed halo-amide, sulphonic acid derivative, sulphonamide, silanol or silylamide of titanium zirconium, hafnium or aluminium or a mixture thereof, and

(ii) a complexing compound selected from the list comprising oximes, hydroxy-Schiff bases, 8-hydroxyquinoline derivatives, 10-hydroxybenzo-[h]-quinoline derivatives, hydrazones and substituted phenols.

The compound is especially useful as a catalyst for the ring opening polymerisation of a lactone, lactam, cyclic ether, cyclic carbonate, cyclic carbamate, lactide, or other cyclic compound which is susceptible to ring-opening polymerisation, especially for polyoxygenate and polypeptide synthesis.

According to a second aspect of the invention we provide a catalyst composition comprising the reaction product of:

(i) an alkoxide, halide, condensed alkoxide, amide, condensed amide, mixed halo-alkoxide or, mixed halo-amide, sulphonic acid derivative, sulphonamide, silanol or silylamide of titanium zirconium, hafnium or aluminium or a mixture thereof, and

(ii) a complexing compound selected from the list comprising oximes, hydroxy-Schiff bases, 8-hydroxyquinoline derivatives, 10-hydroxybenzo-[h]-quinoline derivatives, hydrazones and substituted phenols.

The catalyst composition is preferably of the following general formula Y_{n-(x*z)}-M-Lₓ where Y represents a monovalent ligand (such as alkoxy, amide, sulphonato or silanoxy), n represents the valency of the metal M, x is the no of moles of complexing compound associated with each metal atom and z is the number of covalent bonds formed between each L and the metal M. For example, the catalyst composition is represented by the following structural diagram: 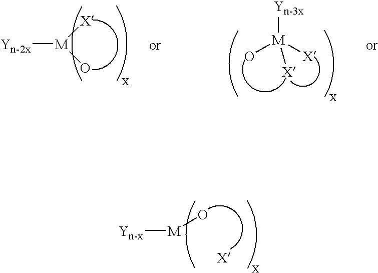
where X′ is N or O and Y is selected from alkoxide, halogen, amide, RS(O)₂O—, [RS(O)₂]₂N—, silanol (R₃SiO) and silylamide (R₃Si)₂N. R may be alkyl or aryl, and is optionally substituted, e.g. CF₃. 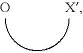
where O is formally anionic and X′ may form a dative bond to a metal, represents a ligand derived from an oxime, hydroxy-Schiff base, 8-hydroxyquinoline derivative, 10-hydroxybenzo-[h]-quinoline derivative, hydrazone or substituted phenol as more specifically described hereinafter.

According to a further aspect of the invention we provide a polymerisable mixture comprising at least one lactone, lactam, cyclic ether, cyclic carbonate, cyclic carbamate, lactide, or other cyclic compound which is susceptible to ring-opening polymerisation, and a catalyst comprising the reaction product of

(i) an alkoxide, condensed alkoxide, amide, condensed amide, mixed halo-alkoxide or, mixed halo-amide, sulphonic acid derivative, silanol or silylamide of titanium zirconium, hafnium or aluminium or a mixture thereof, and

(ii) a complexing compound selected from the list comprising oximes, hydroxy-Schiff bases, 8-hydroxyquinoline derivatives, 10-hydroxybenzo-[h]-quinoline derivatives, hydrazones and substituted phenols.

An alkoxide of titanium zirconium, hafnium or aluminium has the formula M(OR)_{n′} where M represents the metal, R is an alkyl group, and n′=3 or 4. Each R is preferably the same but may be different from one or each other R. More preferably, R contains 1 to 6 carbon atoms and particularly suitable alkoxides include tetra-methoxytitanium, tetra-ethoxytitanium, tetra-isopropoxytitanium, tetra-n-propoxytitanium, tetrabutoxytitanium, tetra-propoxyzirconium, tetra-butoxyzirconium, tetra-n-propoxyhafnium and tetra-n-butoxyhafnium.

An amide of titanium zirconium, hafnium or aluminium has the formula M(NR₂)_{n′} where M represents the metal, R is an alkyl group, and n′=3 or 4. Each R is preferably the same but may be different from one or each other R. More preferably, R contains 1 to 6 carbon atoms and particularly suitable amides include tetra-dimethylamidotitanium, tetra-diethylamidotitanium, tetra-dimethylamidozirconium, tetra-diethylamidozirconium, tetra-dimethylamidohafnium, tetra-diethylamidohafnium.

Condensed alkoxides of titanium, zirconium or hafnium can be represented by the general formula RO[M(OR)₂O]_{n″}R, wherein M and R have the same meaning as discussed above and n″ is an integer. Generally, these condensed alkoxides consist of a mixture containing compounds of the above formula with n″ having a range of values. Preferably n″ has an average value in the range 2 to 16 and, more preferably, in the range 2 to 8. A condensed alkoxide is usually prepared by the controlled addition of water to an alkoxide, followed by removal of alcohol which is displaced. Suitable condensed alkoxides include the compounds known as polybutyl titanate, polybutyl zirconate and polyisopropyl titanate.

Mixed halo-alkoxides of titanium, zirconium and hafnium can be represented by the general formula MXₓ(OR)_{n′-x} wherein X is a halogen atom, preferably Cl. M and R have the same meaning as discussed above, x is a positive integer and n′=3 or 4.

Mixed halo-amides of titanium, zirconium and hafnium can be represented by the general formula MXₓ(NR₂)_{n′-x} wherein X is a halogen atom, preferably Cl. M and R have the same meaning as discussed above, x is a positive integer and n′=3 or 4.

In the sulphonic acid derivatives, RS(O)₂O—, sulphonamides [RS(O)₂O]₂N—, silanol (R₃SiO) and silylamide (R₃Si)₂N, R may be alkyl or aryl, and is optionally substituted, e.g. CF₃.

The oxime, hydroxy-Schiff base, 8-hydroxyquinoline derivative, 10-hydroxybenzo-[h]-quinoline derivatives, hydrazone or substituted phenol (hereinafter referred to as the “complexing compound”) forms, following deprotonation, an anionic ligand which replaces one or more of the alkoxide, halogen, amide, sulphonic acid derivative, silanol or silylamide groups. These anionic ligands all have the capability of binding to the metal both covalently and also of forming a second covalent or coordinating bond to the metal. Some or none of the original alkoxide halogen, amide, sulphonic acid derivative, silanol or silylamide groups groups may remain bonded to the metal following reaction with the complexing compound.

Any such groups remaining on the metal may, optionally, be displaced by reacting the resulting complex with an alcohol, such as phenol for example to form a complex containing an alkoxy group which is different from the alkoxy groups in the metal alkoxide starting material. These compounds are included as compounds of the invention, even when the final product contains an alkoxy group which would not have formed a titanium alkoxide which could have reacted with the complexing compound to form a compound of the invention. In a preferred form of the invention, the metal compound is an alkoxide and at least one alkoxide ligand is attached to the metal atom or atoms. More preferably this alkoxide ligand is a labile alkoxide having from 1 to 8 carbon atoms.

Preferred oximes are aryl-substituted (including polycyclic aryl-) (aromatic or heterocyclic) oximes of Formula 1 or Formula 2, 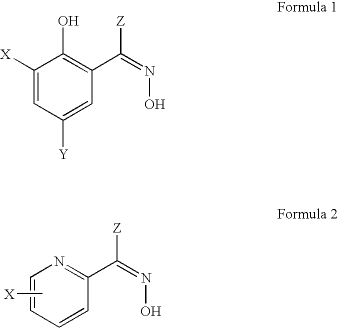
in which X and Y, which may be the same or different, are selected from H, alkyl (preferably C₁-C₆ alkyl, e.g. t-butyl or isopropyl), alkoxy, NO₂, halogen, amino (including alkylamino). When the oximes are polycyclic aryl-substituted oximes such as naphthalene derivatives for example, Formulas 1 and 2 are amended accordingly. Z may be selected from H, or an alkyl aryl or pyridyl group, any of which may be substituted or unsubstituted.

The hydroxy-Schiff bases useful in the invention are of general Formula 3 or 3a: 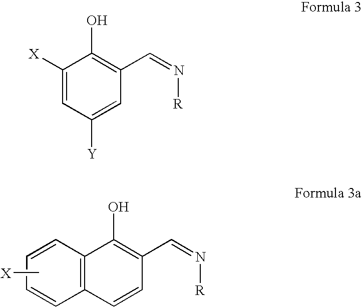
where X and Y represent the same substituents mentioned above and R is substituted or unsubstituted alkyl, including cycloalkyl, aryl, aryloxy, alkoxy, or a polycylic group such as quinolyl. When R is substituted alkyl or aryl, the substituents may be selected from alkyl, alkoxy, nitro, halogen or an and there may be one or more than one subsituent which may be the same or different from each other. Some useful examples of R include isopropyl, t-butyl, adamantyl, ethyl phenyl, phenyl, perfluorophenyl, alkoxyphenyl, bisphenyl, 2,4,6-trimethylphenyl, 2,6 diisopropyl phenyl, 2,4,6-tri-tert-butylphenyl, triphenylmethyl, 2,4,6-triphenylphenyl.

The Schiff bases of the invention include dimeric and trimeric Schiff bases, in which R in Formula 3 or 3a comprises a linking group which is linked to a second or third Schiff base moiety which is preferably of the same composition as the other Schiff base moieties in the molecule. The linking group preferably contains between 1 and 6 atoms which are normally selected from C, N and O. The linking group may be substituted or form part of a longer chain or ring structure. Examples of dimeric and trimeric Schiff bases are shown in Formula 3b and 3c.

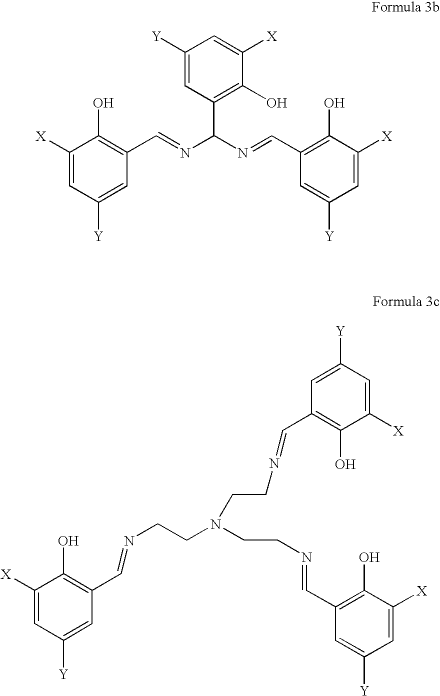

The 8-hydroxyquinoline derivatives and the 10-hydroxybenzo-[h]-quinoline derivatives useful in the invention have the general formula 4 and 5 respectively.

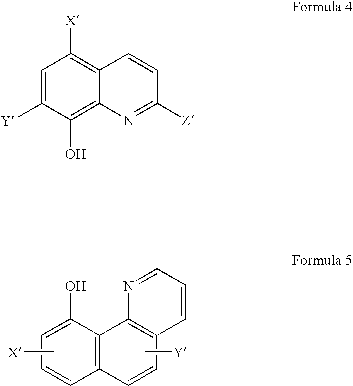

Where X′ and Y′ are, independently H, halogen, NO₂, alkyl or alkenyl and Z′ is alkyl. Some examples of useful 8-hydroxyquinoline derivatives include 8-hydroxyquinoline, 8-hydroxyquinaldine, 5-chloro-8-hydroxyquinoline, 5,7-dichloro-8-hydroxyquinoline, 5-chloro-8-hydroxy-7-iodoquinoline, 8-hydroxy-5-nitroquinoline, 5,7-dibromo-8-hydroxyquinoline, 5,7-dichloro-8-hydroxy-2-methylquinoline, 5,7-dibromo-8-hydroxy-2-methylquinoline, 7-allyl-8-hydroxyquinoline.

Suitable hydrazones are aromatic hydrazones, which may be unsubstituted or substituted at either the aromatic ring or the N atom. Therefore these suitable hydrazones have the following general formula 6:

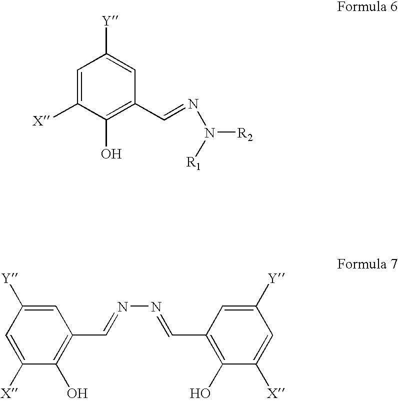

X″ and Y″ are selected from H, (optionally substituted) alkyl (e.g. C₁-C₈ alkyl, such as t-butyl or i-propyl), alkoxy, for example methoxy, aryl, NO₂, or (optionally substituted) amino.

R₁ and R₂ may be H, alkyl or aryl or may be together another hydrazone derivative. In this latter case the molecule is preferably symmetrical so that the two hydrazone derivatives are the same. An example of such a molecule is shown as Formula 7. Polycyclic analogues of these hydrazone derivatives are also included in the suitable hydrazone species for the invention.

Some members of the class of substituted phenols are included hereinbefore either implicitly or explicitly in another class of complexing agents. Other substituted phenols having substituents which include a N, O or S group which can coordinate to a metal atom may also be used as complexing compounds for the invention. Such substituents include hydroxy, hydroxyalkyl, amino, aminoalkyl, oxazole and thiazole-containing groups. The phenol may additionally contain other substituents such as (optionally substituted) alkyl, (e.g. C₁-C₆ alkyl, such as t-butyl or i-propyl), alkoxy, for example methoxy, aryl or NO₂.

Suitable substituted phenols therefore include but are not limited to 2,4-di^{t}butyl-6-amino phenol, 2,4,6-hydroxymethylphenol, 2-benzoxazol-2-yl-phenol, 2-benzothiazol-2-yl-phenol.

The phenol may be substituted by a phenol derivative. In this case it is preferable that the phenol substituent is of a similar composition to the substituted phenol itself or is joined to the substituted phenol by a symmetrical bridging group, so that the resulting molecule is symmetrical. An example of such a substituted phenol is 4,4′-methylene-bis(2,6-di^{t}butylphenol), 2,2′methylene bis(6-^{t}butyl-4-methylphenol), 2,2′ethylidene bis (4,6-di-tert-butyl phenol), and compounds of these bisphenols where the metal M is zirconium or hafnium have not been demonstrated in the prior art. More than one such substituent may be present to provide trisphenol-type compounds such as those illustrated in formula 8. Compounds described in Kim & Verkade (Y. Kim and J. Verkade, Oganometallics 2002, 21, 2395-2399) in which Ti is complexed with a substituted trisphenol of general formula 9 and a 2,6-di-isopropyl-phenoxy ligand are excluded from the scope of this invention.

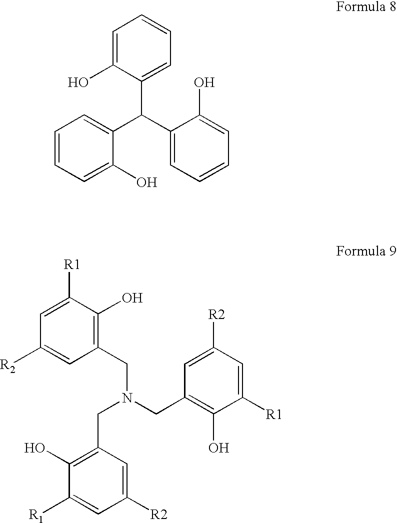

The compounds of the invention may be made by combining a solution of the complexing compound in an inert atmosphere with the alkoxide, halide, condensed alkoxide, amide, mixed halo-alkoxide or mixed halo-amide of titanium zirconium, hafnium or aluminium, with heating to reflux if necessary. The alkoxide, amide etc groups which remain attached to the metal atom may be exchanged for another different group of the same type (e.g. an alkoxide derived from a higher alcohol) or a group of a different chemical type such as a sulphonic acid derivative. The solid complexes may be purified and isolated by standard synthetic techniques such as crystallisation and recrystallised if necessary.

The compounds of the invention may comprise one or more than one metal atom. The complexing compounds, being capable of forming more than one bond with a metal atom, may form bridges between metal atoms to form larger molecules. For example, in a complexing compound containing more than one hydroxy group, each may form a bond to the same or a different metal atom. In this way the architecture of the compound of the invention may be controlled by careful selection of a complexing compound of appropriate functionality.

The monomers used are heterocyclic compounds, usually having oxygen- or nitrogen-containing rings, which are susceptible to ring-opening polymerisation. Such compounds 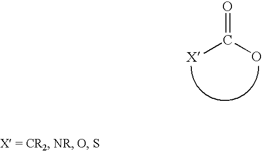
have the general structure:

Examples of such compounds include lactones, lactides and lactams especially δ-valerolactone, ε-caprolactone, and substituted versions thereof; lactide, DL dilactide, diglycolide; cyclic carbonates such as propylene carbonate, 2-methyl-1,3-propane diol carbonate[1,3]Dioxan-2-one, [1,3]Dioxepan-2-one, 5-methylene-[1,3]dioxan-2-one; cyclic carbamates, including substituted carbamates. Co-polymers produced by ring-opening polymerisation of more than one monomer of the same type or of different types, e.g. a lactone-carbonate polymer may be made by the process of the invention. The process is especially useful for making block-copolymers because the ring-opening polymerisation using the catalysts of the invention is a living polymerisation system. Other types of copolymer may also be made by this method.

The amount of catalyst used in the polymerisabon is generally within the range 1:10-1:1000, expressed as a mole ratio of catalyst:total monomer, for example a mole ratio of 1-50-1:500 particularly about 1:100 may be used.

The ring-opening polymerisation reaction is performed using standard methods known in the art. The reactions may proceed in the presence of an initiator, e.g. an alcohol, however, using the catalysts of the invention a separate initiator is not always required. The reaction may be quenched using acetic acid or other suitable compound. The reactions are living polymerisation systems and may be resumed upon addition of further monomer, which may be different to the first monomer, leading to the generation of a block copolymer.

The ring-opening polymerisation reactions may be carried out in a solvent such as toluene, benzene, other aromatic solvent, hexane, heptane, aliphatic hydrocarbons, halogenated hydrocarbons, or other suitable solvent for the type of monomer and conditions used. The reaction conditions are selected to be suitable for the particular reaction to be carried out. The reactions are generally carried out at about room temperature, but higher or lower temperatures may be used if required.

### EXAMPLE 1

### Preparation of bis(2,6-diisopropylphenylsalicyaldimato)bis(isopropoxy) titanate

Ti(OiPr)₂(η²-OC₆H₄C(H)N—(C₆(CH(CH₃)₂)₂H₃)₂

The ligand HOC₆H₄C(H)N—(C₆(CH(CH₃)₂)₂H₃ was made according to the method described in Wang, C. Fredrich, S.; Younkin, T R.; Li, R T.; Grubbs, R H.; Bansleben, D A.; Day, M W. Organometallics, 1998, 17, 3149.

Synthesis of [HOC₆H₄—CH═NC₆H₃(CH(CH₃)₂)₂]

Salicylaldehyde (12.2 g, 100 mmol) was added by syringe, to a stirred solution of 2,6-diisopropylaniline (17.7 g, 100 mmol) in methanol (50 ml) at ambient temperature. p-toluenesulphonic acid (0.2 g) was added to the reaction mixture and a reflux condenser was fitted. The reaction mixture was refluxed for 3 hours, resulting in the formation a yellow solution with a small amount of yellow precipitate. Removal of solvent under reduced pressure resulted in the complete precipitation of the yellow solid, which was re-dissolved in a minimum of fresh dichloromethane (40 ml), with heating. The solution was dried over MgSO₄ and filtered hot to remove insoluble residues. A yellow crystalline solid was obtained on evaporation of the solvent at room temperature over night. The solid was collected by filtration, washed with cold hexane, and dried in vacuo. Yield: 24.8 g, 88%.

NMR analysis was consistent with literature (Grubbs et al).

To a stirred solution of the ligand [HOC₆H₄—CH═NC₆H₃(CH(CH₃)₂)₂] (0.56 g, 2 mmol) in 20 ml of toluene was added Ti(OtPr)₄ (0.3 ml, 1 mmol) dropwise by syringe, at 0° C. The mixture was heated to reflux for two hours. The solution was cooled to room temperature before removal of solvent, under reduced pressure. The yellow residue was dissolved into a minimum of fresh toluene (5 ml), warmed to reflux, and filtered through a Celite pad, into a fresh Schlenk. The filtrate was allowed to stand overnight at room temperature, after which the yellow crystalline product was isolated by filtration and washed with 5 ml of cold hexane and dried in vacuo. Yield: 0.6 g 83%.

Anal. Calculated for C₄₄H₅₈N₂O₄Ti₁: C, 72.7; H, 8.0; N, 3.86, Found: C, 72.3; H, 8.01; N, 3.76;

¹H NMR (300 MHz, 23° C.), CDCl3 (ppm): 0.51 (br-s, 12H, OCH(CH3)2), 1.25 (br-s, 24H, C—CCH(CH3)2), 3.77 (sept, 2H, OCH(CH3)2, 3JHH=7 Hz), 3.87 (sept, 2H, C—C\ddot{H}(CH3)2, 3JHH=9.2 Hz), 6.62-6.65 (m, 4H, CHₐᵣₒₘ), 7.19-7.27 (m, 8H, CHₐᵣₒₘ), 7.35-7.39 (m, 2H, CHₐᵣₒₘ), 8.05 (s, 2H, C(H)=N); 13C NMR (75.5 MHz, 23° C.) CDCl3 (ppm): 25.29, 27.46, 27.48, 77.8, 115.61, 120.0, 124.17, 124.17, 126.92, 134.9, 136.1, 142.2, 152.2, 167.5, 169.5; MS(EI): (m/z).

### EXAMPLE 2

### Preparation of bis(phenylsalicylaldiminato)bis(isopropoxy) titanate

The ligand, phenylsalicylaldimine, was made following the general procedure referenced above by reacting aniline with salicylaldehyde.

Dry toluene (30 ml) was added to a Schlenk tube containing phenylsalicylaldimine, (6 mmol, 1.18 g,) under an inert atmosphere to give a suspension at room temperature. To this suspension was added titanium tetraisopropoxide (3 mmol, 0.9 ml) under a positive pressure of argon using a dry syringe. The resulting suspension was heated to reflux and then cooled to room temperature leaving a yellow solution. Solvent was removed in vacuo until the formation of a yellow precipitate. This was then warmed into a yellow solution which yielded a crop of yellow crystals of bis(phenyl salicylaldiminato)bis(isopropoxy) titanate on standing at 5° C. for 24 hours. These crystals were isolated under dry argon and washed with cold, dry hexane prior to analysis (yield 70%).

### EXAMPLE 3

### (a) Synthesis of [HOC₆H₂Cl₂C(H)N—(C₆(CH(CH₃)₂)₂H₃]

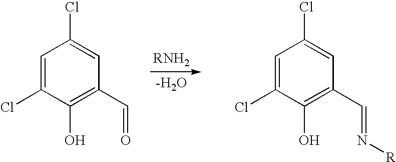

To a stirred solution of 3,5-dichloro-2-hydroxybenzaldehyde, (1.91 g, 10 mmol) in ethanol (100 mL), 2,6-diisopropylaniline, (1.9 mL, 10 mmol) was added. p-toluenesulphonic acid (0.2 g). The reaction mixture was refluxed for 3 hours before the solvent was removed under reduced pressure. This resulted in the precipitation of an orange solid, which was re-dissolved In fresh dichloromethane (40 mL). The solution was dried over MgSO₄ and filtered. An orange solid was obtained on evaporation of the solvent. Yield: 3.03 g, 87%.

NMR analysis was consistent with literature (Grubbs et al).

¹H NMR (CDCl₃, 25°): δ 0.80-2.20 (starting material), 2.85, (m, 2H,^{I}Pr, CH),6.80-7.45 (m, 5H, aromatics), 8.15 (s, 1H, HC═N), 13.86 (s, 1H, OH).

¹³C{¹H} NMR (CDCl₃, 25°): δ 22.1 (^{I}Pr CH₃); δ 26.8 (^{I}Pr CH); δ 118.2, 121.5, 122.0, 121.9, 122.0, 124.7, 128.3, 131.5, 137.2, 143.5, 154.6 (11 aromatic C); δ 163.7 (imine HC═N)

C/H/N Elemental Analysis,

Calculated: C, 65.15; H, 6.04 N, 4.00

Found: C, 65.30; H, 6.13 N, 3.95

### (b) Synthesis of Ti(O^{I}Pr)₂(η²-OC₆H₂Cl₂C(H)N—(C₆(CH(CH₃)₂)₂H₃)₂

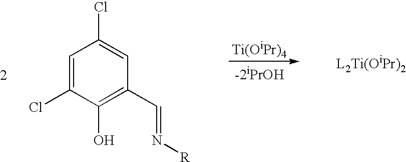

To a stirred solution of ligand [HOC₆H₂Cl₂C(H)N—(C₆(CH(CH₃)₂)₂H₃] (0.67 g, 2 mmol) in 20 mL of toluene, Ti(O^{I}Pr)₄ (0.3 mL, 1 mmol) was added dropwise via a syringe. The mixture was heated to reflux and allowed to stir for 2 hours. The solvent was removed under reduced pressure to give a yellow residue. This was dissolved in minimum hexane to give an initial crop of X-ray-quality yellow crystals. Yield: 0.14 g, 16%. Melting Point; 140.8-147.6° C.

¹H NMR (CDCl₃, 25°): δ 0.70 (d, 12H ^{I}Pr CH₃ Ti(O^{I}Pr)₂), 1.05 (d, 12H ^{I}Pr CH₃), 4.35 (septet, 2H, ^{I}Pr CH) 6.80-7.42 (m, 10H aromatic protons) 7.95(s,1H CH═N)

¹³C{¹H} NMR (CDCl₃, 25°): δ 23.2 (O^{I}Pr CH₃); δ 24.7 (O^{I}Pr aniline CH); δ 26.4 (O^{I}Pr aniline CH₃); δ 78.3 (O^{I}Pr CH); δ 120.9, 122.7, 123.7, 125.4, 133.1, 139.8, 149.6 (7 aromatic C); δ 159.3 (imine HC═N)

C/H/N Elemental Analysis

Calculated: C, 61.12; H, 6.30 N, 3.24

Found: C, 55.90; H, 5.69 N, 3.02

### EXAMPLE 4

### (a) Synthesis of [HOC₆H₃O(CH₃)C(H)N—(C₆(C(CH₃)₃)₃H₂]

To a stirred solution of 2-hydroxy-5-methoxy-benzaldehyde, (1.91 g, 10 mmol) in methanol (100 mL), 2,4,6-tri-tert-butylaniline, (2.6 g, 10 mmol) was added. p-toluenesulphonic acid (0.2 g). The reaction mixture was refluxed for 3 hours. The solvent was removed under reduced pressure to give a yellow precipitate, which was re-dissolved in a minimum of fresh dichloromethane. The solution was then dried over MgSO₄ and filtered to give a yellow solid on evaporation of the solvent. Yield: 3.17 g, 80%.

NMR analysis was consistent with literature (Grubbs et al).

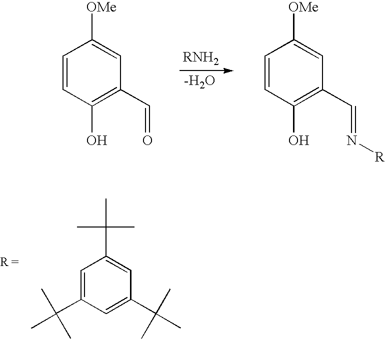

¹H NMR (CDCl₃, 25°): δ 1.28 (s, 27H, ^{t}Bu, CH₃), 3.35 (s, solvent), 3.70 (s, 3H OMe, CH₃), 6.70-7.30 (m, 5H, aromatics), 8.12 (s,1H, HC═N), 12.78 (s, 1H, OH).

¹³C{¹H} NMR (CDCl₃, 250): δ 31.9, 32.5 (ortho ^{t}Bu CH₃); δ 35.2 (para tBu CH₃); δ 36.2 (ortho ^{t}Bu C); δ 51.1 (para ^{t}Bu C); δ 56.3 (OCH₃); δ 115.9, 118.2, 118.6, 120.6, 122.5, 140.3, 146.2, 147.6, 152.7, 155.7 (10 aromatic C); δ 167.9 (imine HC═N)

C/H/N Elemental Analysis

Calculated: C, 78.94; H, 9.43 N, 3.54

Found: C, 78.50; H, 9.39 N, 3.52

### (b) Synthesis of Ti(O^{I}Pr)₃(η²-OC₆H₃OCH₃C(H)N—(C₆(CH(CH₃)₃)₃H₂)

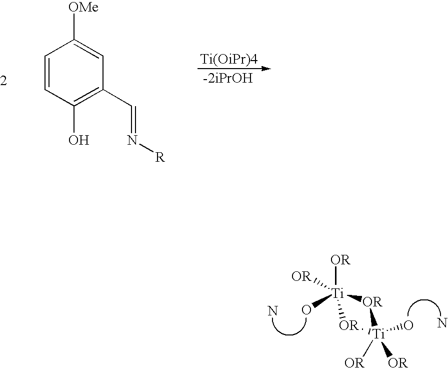

To a stirred solution of ligand [HOC₆H₃O(CH₃)C(H)N—(C₆(C(CH₃)₃)₃H₂] (0.79 g, 2 mmol) in 20 mL of toluene, Ti(O^{I}Pr)₄ (0.3 mL, 1 mmol) was added dropwise via a syringe. The mixture was heated to reflux and allowed to stir for 2 hours. The solvent was removed under reduced pressure to give a yellow residue. This was dissolved in minimum hexane to give an initial crop of X-ray quality yellow crystals. Yield: 0.32 g, 34%. Melting Point; 147.4-150.9° C.

¹H NMR (CDCl₃, 25°): δ 0.80-1.30 (m, 27H ^{t}Bu CH₃, d,12H ^{I}Pr CH₃ Ti(O^{I}Pr)₂) 3.70, 4.55 (septet, 2H, ^{I}Pr CH), 6.64-7.82 (m, 10H aromatic) 8.15 (s, 1H CH═N)

C/H/N Elemental Analysis

Calculated: C, 72.96; H, 9.01 N, 2.94

Found: C, 67.70; H, 9.24 N, 2.72

### EXAMPLE 5

### (a) Synthesis of [HOC₆H₂Cl₂C(H)N—(C₆(C(CH₃)₃)₃H₂]

To a stirred solution of 3,5-dichloro-2-hydroxybenzaldehyde, (1.91 g, 10 mmol) in methanol (100 mL), 2,4,6-tri-tert-butylaniline, (2.6 g, 10 mmol) was added. p-toluenesulphonic acid (0.2 g). The reaction mixture was refluxed for 3 hours. The solvent was removed under reduced pressure to give a yellow precipitate, which was re-dissolved in a minimum of fresh dichloromethane. The solution was then dried over MgSO₄ and filtered to give a yellow solid on evaporation of the solvent. Yield: 2.97 g, 67%.

NMR analysis was consistent with literature (Grubbs et al).

¹H NMR (CDCl₃, 25°): δ 1.35 (s, 27H, ^{t}Bu, CH₃), 7.15-7.75 (m, 4H, aromatics), 8.20 (s, 1H, HC═N), 14.25 (s, 1H, OH).

C/H/N Elemental Analysis

Calculated: C, 69.12; H, 7.66 N, 3.22

Found: C, 68.90; H, 7.59 N, 3.00

### (b) Synthesis of Ti(O^{I}Pr)₃(η²-OC₆H₂Cl₂C(H)N—(C₆(CH(CH₃)₃)₃H₂)

To a stirred solution of ligand [HOC₆H₂Cl₂C(H)N-(C₆(C(CH₃)₃)₃H₂] (0.87 g, 2 mmol) in 20 mL of toluene, Ti(O^{I}Pr)₄ (0.3 mL, 1 mmol) was added dropwise via a syringe. The mixture was heated to reflux and allowed to stir for 2 hours. The solvent was removed under reduced pressure to give a yellow residue. This was dissolved in minimum hexane to give an initial crop of X-ray quality yellow crystals. Yield: 0.14 g, 16%. Melting Point; 161.0-165.5° C.

¹H NMR (CDCl₃, 25°): δ 0.82 (d, 12H ^{I}Pr CH₃ Ti(O^{I}Pr)₂), 1.15 (d, 27H ^{t}Bu CH₃), 4.45 (septet, 2H, ^{I}Pr CH) 7.05-7.90 (m, 16H aromatic protons) 8.35 (s, 1H CH═N)

C/H/N Elemental Analysis

Calculated: C, 65.12; H, 7.61 N, 2.71

Found: C, 61.80; H, 7.98 N, 2.23

### EXAMPLE 6

### Ring-opening polymerisation of ε-caprolactone (CL)

Polymerisation of ε-caprolactone was carried using the following procedure:

All reactions were carried out under an inert atmosphere using flame-dried glassware and dry solvents and reagents. CL was added, with rapid stirring, to 30 ml of a toluene solution containing the desired amount of catalyst to provide 1 mole of catalyst per 100 moles of starting monomer. The reaction mixture was stirred at 50° C. for 2 hours, after which the reaction was quenched by the addition of an excess of 0.35M aqueous acetic acid solution and the polymer precipitated into hexane and isolated, washed and dried under vacuum. The resulting polymers were characterised using gel permeation chromatography in chloroform at 30° C.

The results are shown in Table 1.

TABLE 1

| Catalyst | Initiator | Mw | Mn | Mw/Mn |
|---|---|---|---|---|
| Example 3 | — | 6,620 | 5,490 | 1.2 |
| Example 3* | — | 11,600 | 10,500 | 1.1 |
| Example 4 | — | 11,700 | 7,210 | 1.6 |
| Example 5 | — | 8,010 | 6,080 | 1.3 |
| Ti(OiPr)₄ | — | 10,600 | 6,080 | 1.7 |
| Sn-Schiff-base | Benzyl alcohol | 15,000 | 7,430 | 2.0 |
| complex** | (30 minute initiation time) | | | |
| Al(OiPr)₃ | — | 33,900 | 24,500 | 2.4 |

Notes
*polymerisation run for 18 hours before quenching
**Sn-Schiff base complex according to Formula 10

| | |
|---|---|
| | Formula 10 |
| 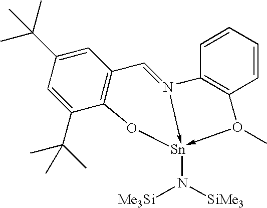 | |

### EXAMPLE 7

### Preparation of a titanium-oxime complex

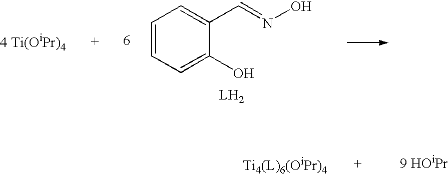

Dry toluene (15 ml) was added to a Schlenk tube containing salicylaldoxime (2.06 g, 15 mmol) under an inert atmosphere. Titanium tetraisopropoxide (3 ml, 10 mmol) was added to this suspension under a positive pressure of argon from a dry syringe. This addition resulted in the immediate formation of an orange solid, which did not enter solution on heating to reflux. The solid was recovered by filtration and found to be soluble only in dimethyl sulphoxide (DMSO). On reduction in volume in vacuo the remaining solution yielded X-ray quality crystals of Ti₄(L)₆(O^{I}Pr)₄, hexa(salicylaldomiminato)tetraisopropoxy titanate. Yield=2.6 g (84%), melting point=145-147° C. The structure of the crystalline product was confirmed using ¹H NMR at 400 MHz in deuterated DMSO and by single-crystal X-ray diffraction studies.

### EXAMPLE 8

### Preparation of bis(salicylaldoximinato)octaisopropoxy titanate

Dry toluene (10 ml) was added to a Schienk containing salicylaldoxime (2.06 g, 15 mmol) under an inert atmosphere. Titanium tetraisopropoxide (6 ml, 20 mmol) was added to the resulting suspension resulting in the formation of an orange solution. The volume of this solution was reduced in vacuo to approximately half of its original volume and left to stand. After standing for 24 hours the solution yielded a crop of orange crystals of Ti₃(L)₂(O^{I}Pr)₈ bis(salicylaidoximinato)octaisopropoxy titanate where L represents the ligand derived from salicylaldoxime. The yield=1.86 g (31.5%), melting point=146-148° C. The structure of the crystalline product was confirmed using ¹H NMR at 400 MHz in CDCl₃ and by single-crystal X-ray diffraction studies

### EXAMPLE 9

### Preparation of bis 8-hydroxyquinolinate bis isopropanolate complex

Dry toluene (20 ml) was added to a Schlenk tube containing 8-hydroxyquinoline (7.23 g, 50 mmol) under an inert atmosphere to give a suspension at room temperature. To this suspension was added titanium tetraisopropoxide (7.5 ml, 7.11 g, 25 mmol) under a positive pressure of argon using a dry syringe. Formation of a yellow suspension occurred immediately and this was stirred for approximately 1 hour. On heating to reflux an orange/yellow solution was formed which on cooling yielded a crop of yellow crystals of bis 8-hydroxyquinolinate bis isopropanolate. Yield=8.02 g (71%) Melting Point=184-185° C. The structure of the crystalline product was confirmed using ¹H NMR at 400 MHz in deuterated DMSO and by single-crystal X-ray diffraction studies

### EXAMPLE 10

### Preparation of titanium bis 8-hydroxyquinolinate bis phenolate

Dry toluene (50 ml) was added to a Schienk tube containing titanium bis 8-hydroxyquinolinate bis isopropanolate, (4.59 g, 10 mmol) and phenol (1.88 g, 20 mmol) under an inert atmosphere. The resulting orange/yellow suspension was heated at reflux for 20 hours to give an orange solution. Approximately 50% of the solvent was removed in vacuo and the resulting suspension heated to give a solution. On cooling to ambient temperature this solution yielded a crop of orange crystals of titanium bis 8-hydroxyquinolinate bis phenolate. Yield=4.33 g (82%), melting point=207-209° C.

### EXAMPLE 11

### Titanium 2,2′methylene bis (6-t-butyl-4-methyl phenolate) bis isopropanolate

Dry toluene (10 ml) was added to a Schlenk tube containing 2,2′methylene bis (6-tert-butyl-4-methyl phenol) (3.41 g, 10 mmol) under an inert atmosphere. To this suspension was added titanium tetraisopropoxide (3.0 ml, 10 mmol) under a positive pressure of argon using a dry syringe. The resulting red/brown suspension was heated to form a red solution, which on cooling yielded Ti 2,2′methylene bis (6-tert-butyl-4-methyl phenolate) bis isopropanolate as a crop of red crystals. Yield=2.83 g (56%), melting point=83-85° C. The structure of the crystalline product was confirmed using ¹H NMR at 400 MHz in CDCl₃

### EXAMPLE 12

### Titanium 2,2′ethylidene bis (4,6-di-tert-butyl phenolate) bis isopropanolate

Dry toluene (10 ml) was added to a Schienk tube containing 2,2′ethylidene bis (5,6-di-tert-butyl phenol) (4.39 g, 10 mmol) under an inert atmosphere. To this suspension was added titanium tetraisopropoxide (3.0 ml, 10 mmol) under a positive pressure of argon using a dry syringe. The resulting orange suspension was heated with stirring until the solid had entirely entered solution. On cooling to ambient temperature the solution yielded Ti2,2′ethylidene bis (4,6-di-tert-butyl phenolate) bis isopropanolate as a crop of bright orange crystals. Yield=3.339 (55.3%), melting point=94-96° C. The structure of the crystalline product was confirmed using ¹H NMR at 400 MHz in CDCl₃

### EXAMPLE 13

### Zirconium bis 2,2′ethylidene bis (4,6-di-tert-butyl phenolate)

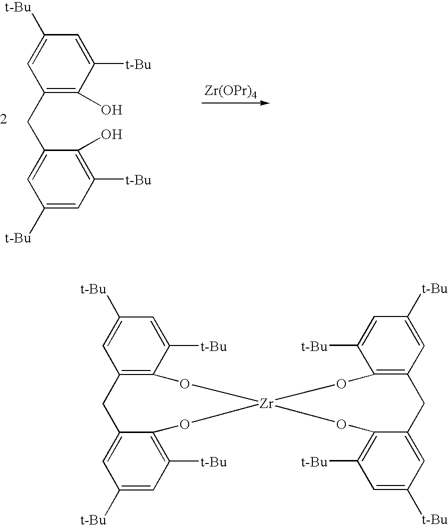

Dry toluene (5 ml) was added to a Schlenk tube containing 2,2′ethylidene bis (5,6-di-tert-butyl phenol) (2.20 g, 5 mmol) under an inert atmosphere. To this suspension was added zirconium tetra-n-propoxide (1.7 ml, 5 mmol) under a positive pressure of argon using a dry syringe. Precipitation occurred immediately and the solvent was removed in vacuo to leave a white solid. Dry THF (5 ml) was added to this solid and the resulting suspension heated to reflux to give a pale yellow solution which on standing yielded Zr bis 2,2′ethylidene bis (4,6-di-tert-butyl phenolate) as a crop of clear crystals. Yield=1.32 g (55% based on the ligand) Melting point 185° C. (dec.) The structure of the crystalline product was confirmed using ¹H NMR at 400 MHz in CDCl₃

### EXAMPLE 14

### Titanium 4,4′ methylene-(2,6-di-tert-butyl phenol)(2,6 di-tert-butyl phenolate) tris isopropanolate

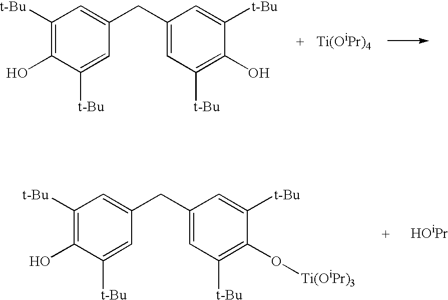

Dry hexane (5 ml) was added to a Schlenk tube containing 4,4′ methyl ene bis (2,6-di-tert-butyl phenol) (2.12 g, 5 mmol) under an inert atmosphere. Titanium tetraisopropoxide (1.5 ml, 5 mmol) was added to this suspension under a positive pressure of argon using a dry syringe. A yellow solution was formed immediately. Approximately 50% of the solvent was removed in vacuo and the remaining yellow solution was placed in the freezer. On standing at this temperature for 24 hours a large amount of a yellow product precipitated from solution and was isolated. Yield=2.02 g (62.4%). The structure of the crystalline product was confirmed using ¹H NMR at 400 MHz in CDCl₃

### EXAMPLE 15

### 4,4′-methylene bis(2,6 di-tert-butylphenolate) bis titanium tris isopropanolate

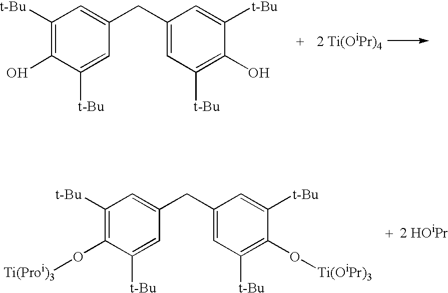

Dry hexane (5 ml) was added to a Schlenk tube containing 4,4′ methylene bis (2,6-di-tert-butyl phenol) (2.12 g, 5 mmol) under an inert atmosphere. Titanium tetraisopropoxide (3.0 ml, 10 mmol) was added to this suspension under a positive pressure of argon using a dry syringe. A yellow solution was formed immediately. Approximately 50% of the solvent was removed in vacuo and the remaining yellow solution was placed in the fridge. On standing at this temperature for 24 hours a large amount of a yellow fibrous product, 4,4′-methylene bis(2,6 di-tert-butylphenolate) bis titanium tris isopropanolate, precipitated from solution and was isolated. Yield=3.12 g (71.6%), melting point=75-77° C. The structure of the crystalline product was confirmed using ¹H NMR at 400 MHz in CDCl₃

### EXAMPLE 16

### Complex between three equivalents of titanium isopropoxide and 1,3,5-trimethyl-24-6-tris (3,5-di-tert-butyl-4-hydroxybenzyl) benzene

Dry hexane (15 ml) was added to a Schienk tube containing 1,3,5-trimethyl-2-4-6-tris(3,5-di-tert-butyl-4-hydroxybenzyl)benzene (3.88 g, 5 mmol) under an inert atmosphere. To this suspension was added titanium tetraisopropoxide (4.5 ml, 15 mmol) under a positive pressure of argon from a dry syringe. A pale yellow solution was formed immediately. Approximately 50% of the solvent was removed in vacuo and the resulting solution placed In the freezer. On standing for 24 hours in the freezer the solution yielded 10 as a crop of yellow/white crystals which re-dissolved on warming to room temperature. The crystals were recovered by filtration at 0° C. but a significant amount was lost due to their high solubility. The yield=1.8 g (24.9%) melting point=183-185° C. The structure of the crystalline product was confirmed using ¹H NMR at 400 MHz in CDCl₃ and by single-crystal X-ray diffraction studies.

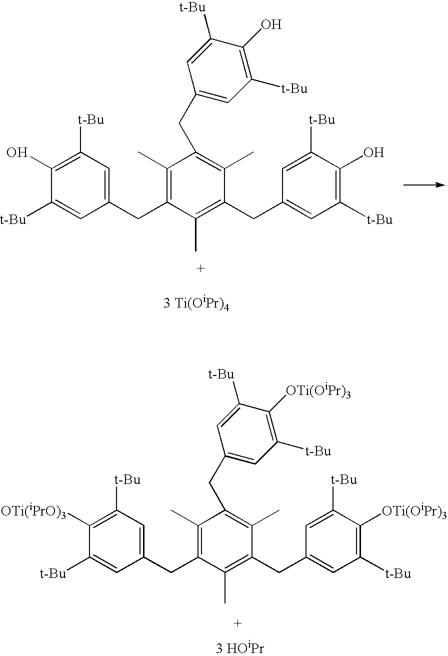

### EXAMPLE 17

### Complex between titanium tetra isopropoxide and 2,6 bis hydroxymethyl-p-cresol

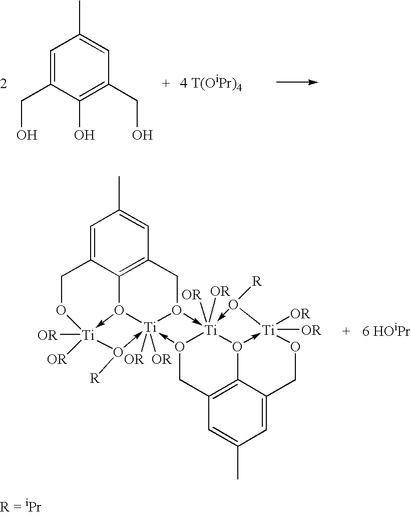

Dry hexane (10 ml) was added to a Schlenk tube containing 2,6 bis hydroxymethyl-p-cresol (1.68 g, 10 mmol) under an Inert atmosphere. To this suspension was added titanium tetraisopropoxide (6.0 ml, 20 mmol) under a positive pressure of argon from a dry syringe. This resulted in the formation of an orange brown suspension that was filtered to leave a pale orange solution and left to stand for 24 hours. This solution yielded a crop of small, clear crystals of the product. The yield=3.80 g (34.2%), melting point=94-97° C. The structure of the crystalline product was confirmed using ¹H NMR at 400 MHz in CDCl₃ and by single-crystal X-ray diffraction studies.

### EXAMPLE 18

### Preparation of bis(2,4-di-tert-butyl-salicylaldehyde hydrazonato)bis(isopropoxy) titanate

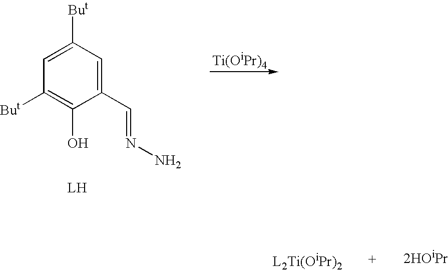

Dry toluene (10 ml) was added to a Schlenk tube containing 2,4-di-tert-butyl-salicylaldehyde hydrazone, 2 mmol, 0.5 g,) under an inert atmosphere to give a suspension at room temperature. To this suspension was added titanium tetraisopropoxide (1 mmol, 0.3 ml) under a positive pressure of argon using a dry syringe. The resulting suspension was heated to reflux and then cooled to room temperature leaving a yellow solution. Solvent was removed in vacuo until the formation of a yellow precipitate. This was then warmed into a yellow solution which yielded a crop of yellow crystals of bis(2,4-di-tert-butyl-salicylaldehyde hydrazonato)bis(isopropoxy) titanate on standing at 5° C. for 24 hours. These crystals were isolated under dry argon and washed with cold, dry hexane prior to analysis (yield 73%). The structure of the product was confirmed using ¹H NMR at 400 MHz in CDCl₃ and by single-crystal X-ray diffraction studies.

1. A process for the preparation of a polymer comprising the step of performing a ring-opening polymerisation reaction of at least one lactone, lactam, cyclic ether, cyclic carbonate, cyclic carbamate, lactide, or other cyclic compound which is susceptible to ring-opening polymerisation, in the presence of a catalyst which comprises the reaction product of
(i) at least one compound of titanium, zirconium or hafnium which is selected from the group consisting of an alkoxide, halide, condensed alkoxide, amide, condensed amide, mixed halo-alkoxide, mixed halo-amide, sulphonic acid derivative, sulphonamide, silanol and silylamid, and
(ii) a complexing compound selected from the the group consisting of oximes, hydroxy-Schiff bases, 8-hydroxyquinoline derivatives, 10-hydroxybenzo-[h]-quinoline derivatives, hydrazones, phenol and phenol substituted with a hydroxy, hydroxyalkyl, amino, amioalkyl, nitro, oxazole, thiazole, alkyl, or alkoxy group.

2. A process according to claim 1, wherein the complexing compound is an aryl-substituted (including polycyclic aryl-) (aromatic or heterocyclic) oxime of Formula 1 or Formula 2, 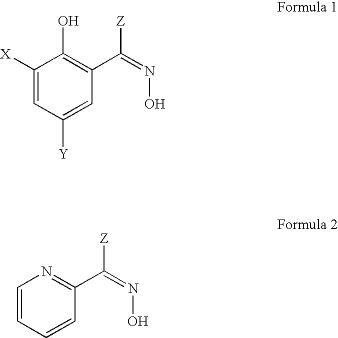
in which X and Y, which may be the same or different, are selected from H, alkyl, alkoxy, NO₂, halogen, amino (including alkylamino) and Z is selected from H, or an alkyl aryl or pyridyl group, any of which may be substituted or unsubstituted.

3. A process according to claim 1, wherein the complexing compound is a hydroxy-Schiff base of general Formula 3 or 3a, 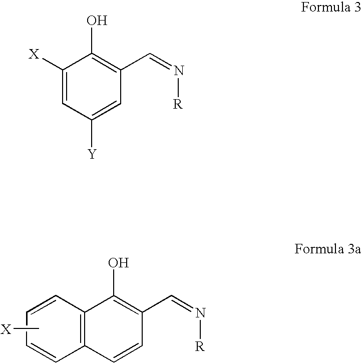
where X and Y are selected from H, alkyl, alkoxy, NO₂, halogen, amino (including alkylamino) and R is substituted or unsubstituted alkyl, including cycloalkyl, aryl, aryloxy, alkoxy, or a polycylic group such as quinolyl.

4. A process according to claim 3 wherein the hydroxy Schiff base is a dimeric or trimeric Schiff base, in which R in Formula 3 or 3a comprises a linking group which is linked to a second or third Schiff base moiety and said linking group contains between 1 and 6 atoms which comprise one or more of C, N and O.

5. A process according to claim 1, wherein the complexing compound is a 8-hydroxyquinoline derivative of the general formula 4: 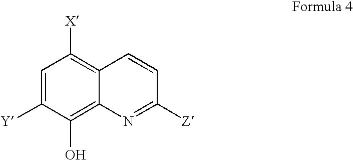
where X′ and Y′ are, independently H, halogen, NO₂, alkyl or alkenyl and Z′ is alkyl.

6. A process according to claim 1, wherein the complexing compound is a 10-hydroxybenzo-[h]-quinoline derivative of the general formula 5.

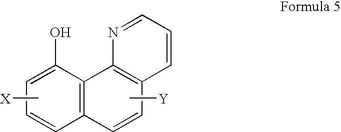

7. A process according to claim 1, wherein the complexing compound is an aromatic hydrazone, which may be unsubstituted or substituted at either the aromatic ring or the N atom.

8. (canceled)

9. A catalyst for the ring opening polymerisation of a lactone, lactam, cyclic ether, cyclic carbonate, cyclic carbamate, lactide, or other cyclic compound which is susceptible to ring-opening polymerisation comprising the reaction product of (i) at least one compound of titanium, zirconium or hafnium which is selected from the group consisting of an alkoxide, halide, condensed alkoxide, amide, condensed amide, mixed halo-alkoxide, mixed halo-amide, sulphonic acid derivative, sulphonamide, silanol and silylamide, and
(ii) a complexing compound selected from the list comprising oximes, hydroxy-Schiff bases, 8-hydroxyquinoline derivatives, 10-hydroxybenzo-[h]-quinoline derivatives, hydrazones, phenol and phenol substituted with a hydroxy, hydroxyalklyl, amino, amioalkyl, nitro, oxazole, thiazole, alkyl, substituted alkyl, or alkoxy group.

10. A polymerisable mixture comprising at least one lactone, lactam, cyclic ether, cyclic carbonate, cyclic carbamate, lactide, or other cyclic compound which is susceptible to ring-opening polymerisation, and a catalyst comprising comprising the reaction product of
(i) at least one compound of titanium, zirconium or hafnium which is selected from the group consisting of an alkoxide, halide, condensed alkoxide, amide, condensed amide, mixed halo-alkoxide or, mixed halo-amide, sulphonic acid derivative, sulphonamide, silanol and silylamide, and
(ii) a complexing compound selected from the list comprising oximes, hydroxy-Schiff bases, 8-hydroxyquinoline derivatives, 10-hydroxybenzo-[h]-quinoline derivatives, hydrazones, phenol and phenol substituted with a hydroxy, hydroxyalklyl, amino, amioalkyl, nitro, oxazole, thiazole, alkyl, substituted alkyl, or alkoxy group.

11. A catalyst according to claim 9, wherein the complexing compound is an aryl-substituted (including polycyclic aryl-) (aromatic or heterocyclic) oxime of Formula 1 or Formula 2, 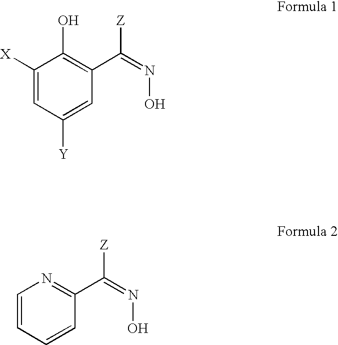
in which X and Y, which may be the same or different, are selected from H, alkyl, alkoxy, NO₂, halogen, amino (including alkylamino) and Z is selected from H, or an alkyl aryl or pyridyl group, any of which may be substituted or unsubstituted.

12. A catalyst according to claim 9, wherein the complexing compound is a hydroxy-Schiff base of general Formula 3 or 3a, 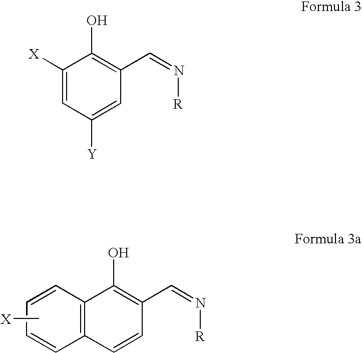
where X and Y are selected from H, alkyl, alkoxy, NO₂, halogen, amino (including alkylamino) and R is substituted or unsubstituted alkyl, including cycloalkyl, aryl, aryloxy, alkoxy, or a polycylic group such as quinolyl.

13. A catalyst according to claim 12 wherein the hydroxy Schiff base is a dimeric or trimeric Schiff base, in which R in Formula 3 or 3a comprises a linking group which is linked to a second or third Schiff base moiety and said linking group contains between 1 and 6 atoms which comprise one or more of C, N and O.

14. A catalyst according to claim 9, wherein the complexing compound is a 8-hydroxyquinoline derivative of the general formula 4: 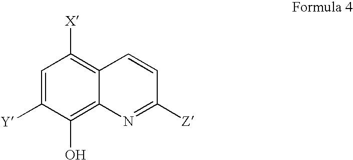
where X′ and Y′ are, independently H, halogen, NO₂, alkyl or alkenyl and Z′ is alkyl.

15. A catalyst according to claim 9, wherein the complexing compound is a 10-hydroxybenzo-[h]-quinoline derivative of the general formula 5.

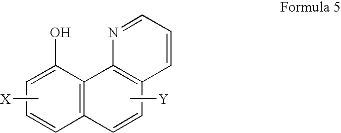

16. A catalyst according to claim 9, wherein the complexing compound is an aromatic hydrazone, which may be unsubstituted or substituted at either the aromatic ring or the N atom.

17. A polymerisable mixture according to claim 10, wherein the complexing compound is an aryl-substituted (including polycyclic aryl-) (aromatic or heterocyclic) oxime of Formula 1 or Formula 2, 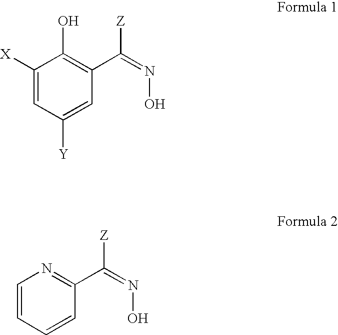
in which X and Y, which may be the same or different, are selected from H, alkyl, alkoxy, NO₂, halogen, amino (including alkylamino) and Z is selected from H, or an alkyl aryl or pyridyl group, any of which may be substituted or unsubstituted.

18. A polymerisable mixture according to claim 10, wherein the complexing compound is a hydroxy-Schiff base of general Formula 3 or 3a, 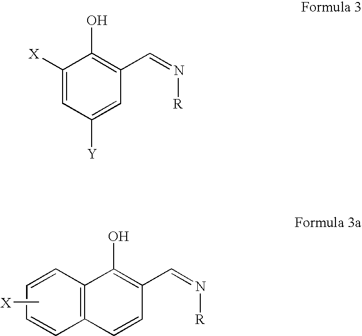
where X and Y are selected from H, alkyl, alkoxy, NO₂, halogen, amino (including alkylamino) and R is substituted or unsubstituted alkyl, including cycloalkyl, aryl, aryloxy, alkoxy, or a polycylic group such as quinolyl.

19. A polymerisable mixture according to claim 18, wherein the hydroxy Schiff base is a dimeric or trimeric Schiff base, in which R in Formula 3 or 3a comprises a linking group which is linked to a second or third Schiff base moiety and said linking group contains between 1 and 6 atoms which comprise one or more of C, N and O.

20. A polymerisable mixture according to claim 10, wherein the complexing compound is a 8-hydroxyquinoline derivativeof the general formula 4: 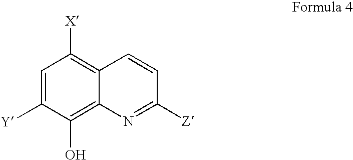
where X′ and Y′ are, independently H, halogen, NO₂, alkyl or alkenyl and Z′ is alkyl.

21. A polymerisable mixture according to claim 10, wherein the complexing compound is a 10-hydroxybenzo-[h]-quinoline derivative of the general formula 5.

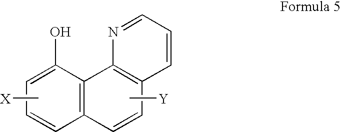

22. A polymerisable mixture according to claim 10, wherein the complexing compound is an aromatic hydrazone, which may be unsubstituted or substituted at either the aromatic ring or the N atom.

23. A process according to claim 2, wherein X and Y, which may be the same or different, are C₁-C₆ alkyls.

24. A process according to claim 3, wherein X and Y, which may be the same or different, are C₁-C₆ alkyls.

25. A catalyst according to claim 11, wherein X and Y, which may be the same or different, are C₁-C₆ alkyls.

26. A catalyst according to claim 12, wherein X and Y, which may be the same or different, are C₁-C₆ alkyls.

27. A polymerisable mixture according to claim 17, wherein X and Y, which may be the same or different, are C₁-C₆ alkyls.

28. A polymerisable mixture according to claim 18, wherein X and Y, which may be the same or different, are C₁-C₆ alkyls.
